(19) United States
(12) Patent Application Publication
(10) Pub. No.: US 2026/0312515 A1
(43) Pub. Date: Oct. 8, 2026

(54) ARTIFICIAL LOADS FOR POWER SPIN UP

(71) Applicant: Blue Vigil LLC, Reston, VA (US)

(72) Inventors: Robert Schumann, Reston, VA (US); Charles Anthony Eldering, Reston, VA (US)

(21) Appl. No.: 19/169,148

(22) Filed: Apr. 3, 2025

(51) Int. Cl. H02P 9/08; B64U 10/60; B64U 50/34; H02P 101/30

(52) U.S. Cl. CPC H02P 9/08; B64U 10/60; B64U 50/34; H02P 2101/30

(57) ABSTRACT

Systems and methods for the creation of artificial loads to spin up a generator or other power source before connection to the actual load are presented. The systems allow the power source to ramp up to provide the desired power at specified voltage and current before connection to the actual load, thus ensuring that full power is available for the actual load and prevent damage to the actual load due to under-voltage or lack of current.

### BACKGROUND

There are various environments where a significant electrical load is placed on a generator or other power source in an almost instantaneous fashion. An example is the field of drones, where a drone that is being launched draws a load of 3-4 kW in a number of milliseconds. Typically, generators are not able to provide such power in such a short time. Systems and methods are needed to prepare the generator or other power source for the actual load so that voltage appearing at the actual load stays within the appropriate operating limits.

### SUMMARY

Artificial loads are presented to a generator in an initial time period, creating a demand that causes the generator to spin up and produce the required power. The artificial load is used to bring the generator up to full speed and power capacity before switching the actual load (e.g. drone) into the system. By waiting to switch the actual load into the system the correct voltage can be maintained when the load is placed into the system. This ensures that the load sees the appropriate power both in terms of voltage and current and avoids potentially dangerous, destructive, or even catastrophic conditions with the load demanding a certain operating current but having the voltage from the generator collapse.

Allowing the generator to reach the appropriate operating power in terms of maintaining the correct voltage while providing the significant current required by the load can be particularly important in the launching of drones. For example, when the drone carries heavy loads, where both the correct voltage and current need to be maintained to allow the rotors to spin up and obtain liftoff, failure to maintain the appropriate voltage can result in instability of the drone and/or damage to the motors.

In an embodiment, the requirement for power is detected, either through an explicit “start” or “launch” button or via detection of initial movement of the joystick in the direction indicating launch is requested and generating an initial launch signal. This launch signal is both to switch an artificial or “false” load into the circuit as well as to generate a delayed launch signal. The delayed launch signal is used to remove the false load and place the actual load in the circuit to initiate the desired process (e.g. launching of the drone or other power-demanding task). The delayed launch signal is generated through the use of an analog or digital delay that receives the launch signal and subsequently, after a predetermined or preprogrammed time, generates the launch signal.

In an embodiment, a mechanical system is used to create an artificial load. In the case of a drone this can be accomplished by restraining the drone mechanically via a tether or through electromechanical, mechanical, or electromagnetic restraints which hold the drone in place while the motors are spun up. In an embodiment, tension is maintained on the tether of a tethered drone to create a mechanical restraint and artificial load. Using a mechanical load as the false load accomplishes the task of allowing the generator to achieve full power capacity while the motors of the drone are spinning up. Takeoff is not permitted until the generator reaches full power to support the drone.

In an embodiment, the artificial load is based on electrical means, transistors (e.g. power field effect transistors) in combination with passive elements such as resistors, capacitors and inductors, passive elements alone, heating coils (in an appropriate insulated chamber) or other components that can dissipate electrical power. The artificial load is connected to the generator or other power source and used to allow the generator to spin up to full power before connecting it to the drone when the delayed launch signal is received.

In an embodiment, the power source (generator or other source) can be characterized via a test to determine the response curve. The artificial load system can be customized to the response curve of the generator to minimize the spin up time without damage to the power source.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTIONS OF FIGURES

FIG. 1 illustrates a system for flying a tethered drone containing a lighting system from a drone cabinet with a battery pack and an external generator, in accordance with example embodiments;

FIG. 2A shows the power demand curve according to changes in the engine speed over time, in accordance with example embodiments;

FIG. 2B shows the generator voltage curve when an initial heavy load is placed on the generator, in accordance with example embodiments;

FIG. 3 shows a false load implemented with the tethered drone, in accordance with example embodiments;

FIG. 4 shows a block diagram for implementing a false load in conjunction with a generator, in accordance with example embodiments;

FIG. 5. shows a flowchart for implementing a false load in conjunction with a generator, in accordance with example embodiments;

FIG. 6 shows a drone launch console including a joystick and a function button with an LED above it (launch button), in accordance with example embodiments;

FIG. 7 shows a representative joystick circuit, in accordance with example embodiments;

FIGS. 8A and 8B show analog and microprocessor controlled false load systems respectively, in accordance with example embodiments; and

FIGS. 9A, 9B and 9C illustrate techniques for mechanical constraint of the drone to create a false load including tether resistance, mechanical locking, and electromagnetic restraint, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

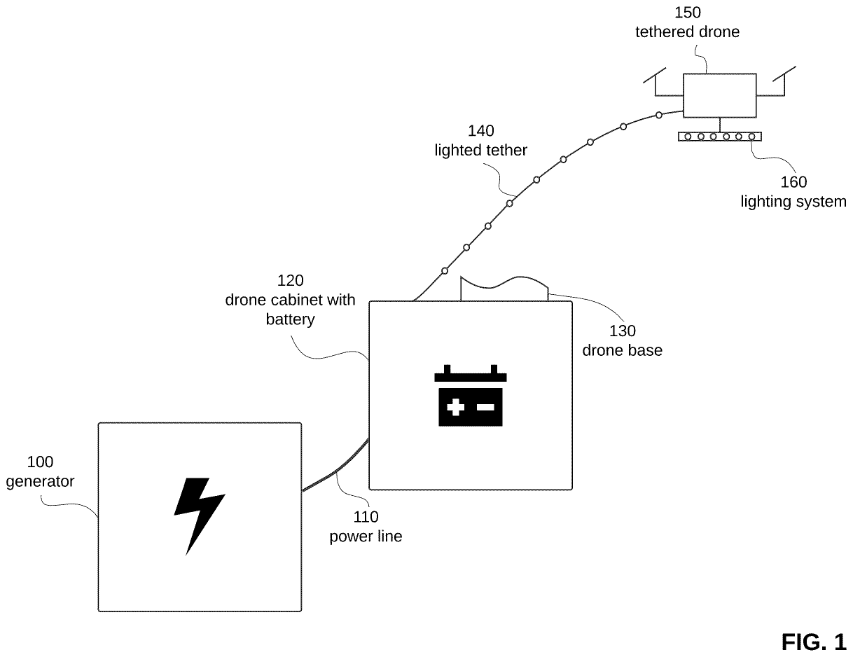

FIG. 1 illustrates a system 10 for launching and operating a tethered drone 150 incorporating a drone cabinet 120 containing a battery or batteries, a drone base 130 for holding the drone 150 prior to launch and a lighted tether 140. Lighted tether 140 serves to supply tethered drone 150 with power via a conductive wire, as well as providing for data transfer to/from drone cabinet 120. In an embodiment, power is supplied to tethered drone 150 via its original battery system such that tethered drone 150 operates in a mode similar to as if it was not tethered, with no alterations to the operating code of the drone necessary.

Referring again to FIG. 1, a generator 100 can be used and connected to drone cabinet 120 via power line 110 to supply power. This allows the system to operate for extended periods of time and is not limited by the power capacity of the battery in drone cabinet 120 or the internal batteries of tethered drone 150.

In an embodiment, tethered drone 150 incorporates a lighting system 160. Lighting system 160 can be used to illuminate a ground area at night. Applications for such tethered drone light systems include nighttime construction, sports played at night, illumination of areas for security, and observation of areas a nighttime. In an embodiment, an imaging and sensing system is also contained in or integrated to tethered drone 150.

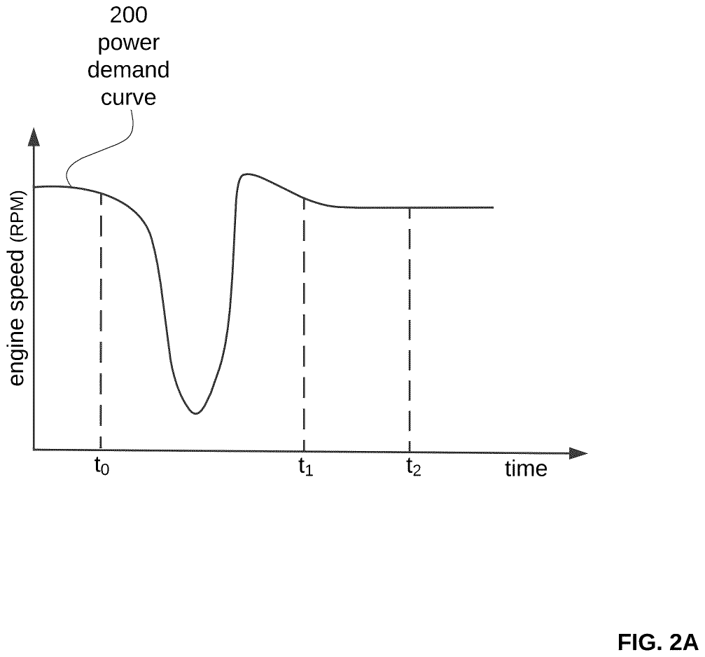

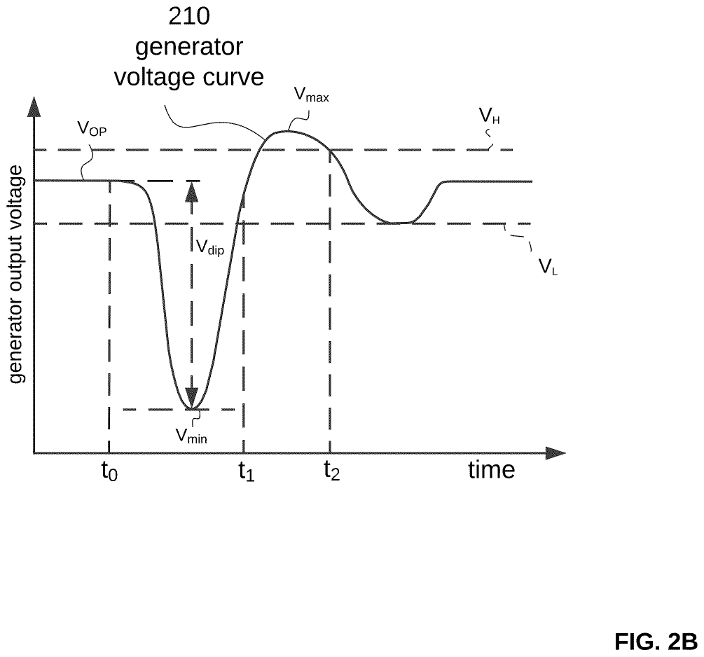

FIG. 2A illustrates a power demand curve showing the impact of power demand on a generator when a sudden load at time t₀ is placed across the generator, causing a drop in revolutions per minute of the generator between time t₀ and time t₁ due to the sudden increased electromotive force experienced by the windings of the generator as it attempts to provide the current demanded by the load. As illustrated, by time t₁ the revolutions per minute of the generator have recovered from the demand and reached steady state by time t₂.

FIG. 2B illustrates the generator output voltage when a sudden load is placed on the generator. As will be understood by one of skill in the art, when a significant or heavy load is placed on the generator at time t₀, the generator output voltage can drop from its operating voltage V_{OP} to a low voltage Vₘᵢₙ between time t₀ and time t₁. This voltage drop is represented as V_{dip}. As the generator recovers the voltage can overshoot the operating voltage beginning at time t₁, reaching Vₘₐₓ between time t₁ and time t₂. At some period after time t₂ the voltage stabilizes and remains between the operating limits of V_{L} and V_{H}.

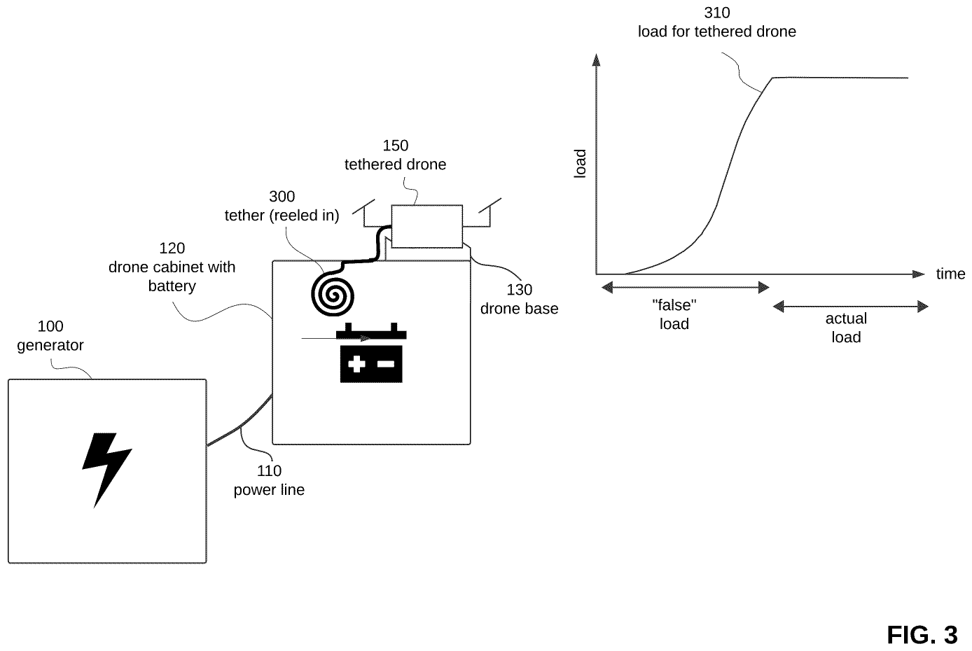

Referring to FIG. 3, the tethered drone system 10 of FIG. 1 is illustrated with tether 300 reeled in prior to a launch, with tethered drone 150 residing in or on drone base 130. The system 10 is configured to implement an artificial or false load which is initially introduced into the system to allow time for the generator to achieve operating conditions (e.g. sufficient rotations per minute) such that a load for the tethered drone 310 can safely be provided to tethered drone 150.

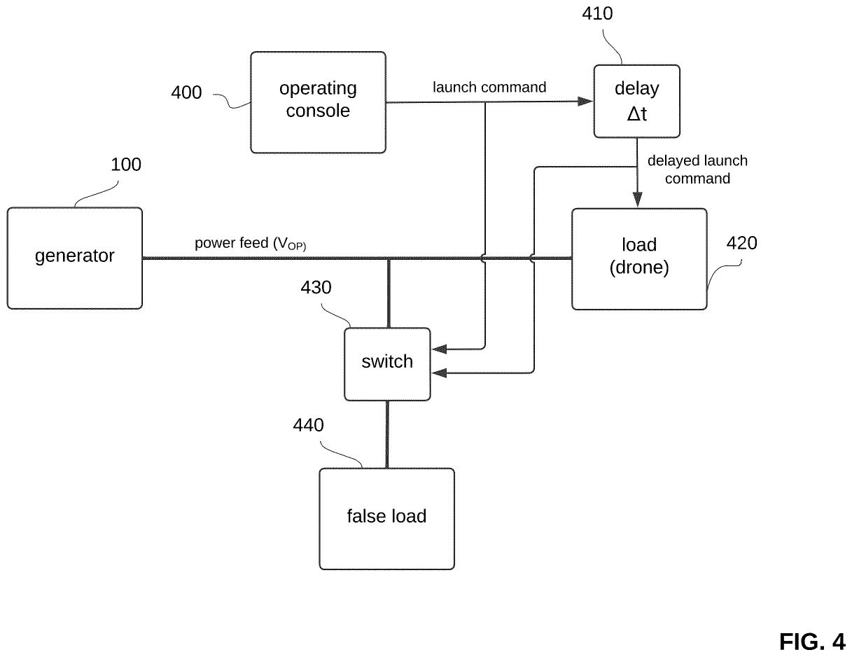

FIG. 4 illustrates a block diagram for the system 10 to present a false load to a generator. Generator 100 provides power at the prescribed operating voltage (e.g., V_{OP}) to a load 420. When a start or launch command is given via operating console 400, a delay 410 is used to create a delayed launch command. The launch command is presented to switch 430. Receipt of the launch command at the switch 430 results in the connection of the false load 440 to generator 100 to be established. Once the delay time Δt is reached, the delayed launch command is issued both to the switch 430 causing the false load 440 to disconnect, and to the load (drone) 420 to initiate the actual launch.

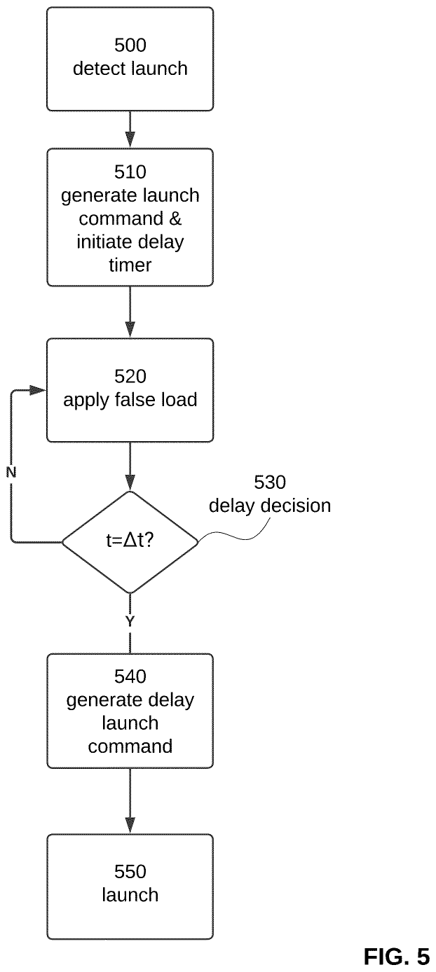

FIG. 5 illustrates a flowchart for the process to present the false load in which a detect launch step 500 is executed when a launch signal is received, followed by a generate launch command & initiate timer delay step 510. The false load is applied in apply false load step 520 and a timer is started. A delay decision test 530 is performed to determine when the appropriate delay Δt has been reached. If it is not reached, the system maintains the false load applied in apply false load step 520. In response to the system determining that t=Δt, a launch command is generated in generate launch command step 540 and the launch is initiated in launch step 550.

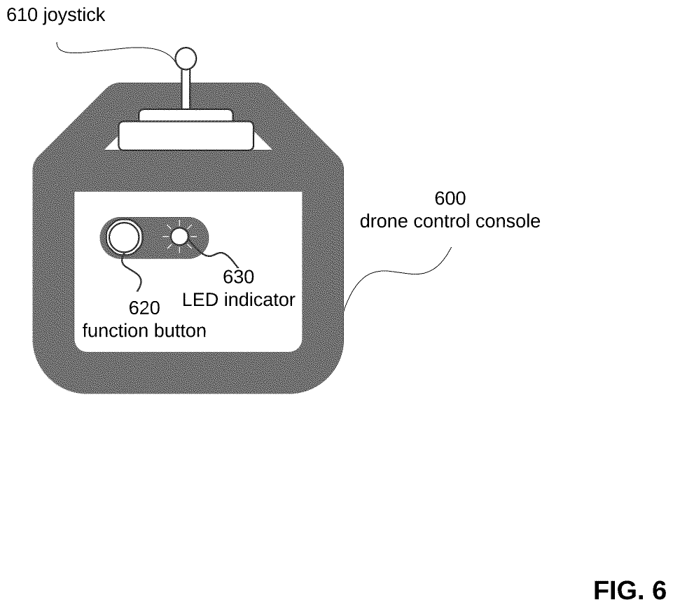

FIG. 6 illustrates a drone control console controller for a drone including a joystick 610. In an embodiment, a function button 620 is present and works in conjunction with LED indicator 630 to indicate the state of a function or process. In an embodiment, function button 620 is used to initiate a launch, and LED indicator 630 provides notification that the system is ready for launch. For example, in one embodiment, the operator pushes function button 620 to initiate launch and LED indicator 630 turns red to indicate that the system is not ready. The launch signal generated by function button 620 is used both to place the false load into the system as well as causing the LED to light up red. After the specified delay and once the generator is ready for the actual load, the launch signal is generated, causing the LED indicator 630 to turn green and indicating to the operator that they can use joystick 610 to launch the drone. In an embodiment, joystick 610 is disabled until the delayed launch signal is generated.

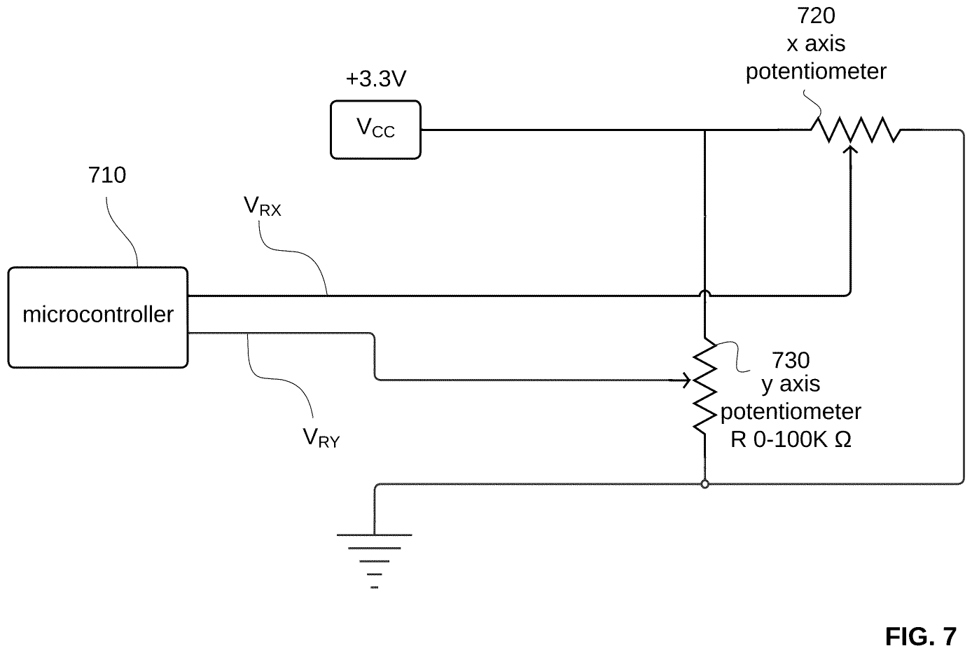

FIG. 7 illustrates an exemplary joystick system for joystick 610, in which the position of the joystick is monitored on two axes via x-axis potentiometer 720 and y-axis potentiometer 730. The corresponding voltages V_{RX} and V_{RY} are monitored by microcontroller 710, which contains analog-to-digital (A/D) circuitry to convert the voltage levels to digital representations. In an embodiment, a threshold is set for movement on a particular axis (e.g. the y-axis that is typically used for altitude control in a drone) such that when the joystick is moved in a particular direction (e.g. to initiate a launch) a launch signal is generated to place false load 440 in the system. Microcontroller 710 can be programmed to use the false load signal to initiate a timer and generate a subsequent delayed launch signal to actually launch the drone 150. This eliminates the need for an explicit launch button and allows the operator to operate the joystick to launch the drone 150 in a conventional manner but forcing a delay in the system 10 to accommodate the connection to the artificial load to allow generator 100 to spin up.

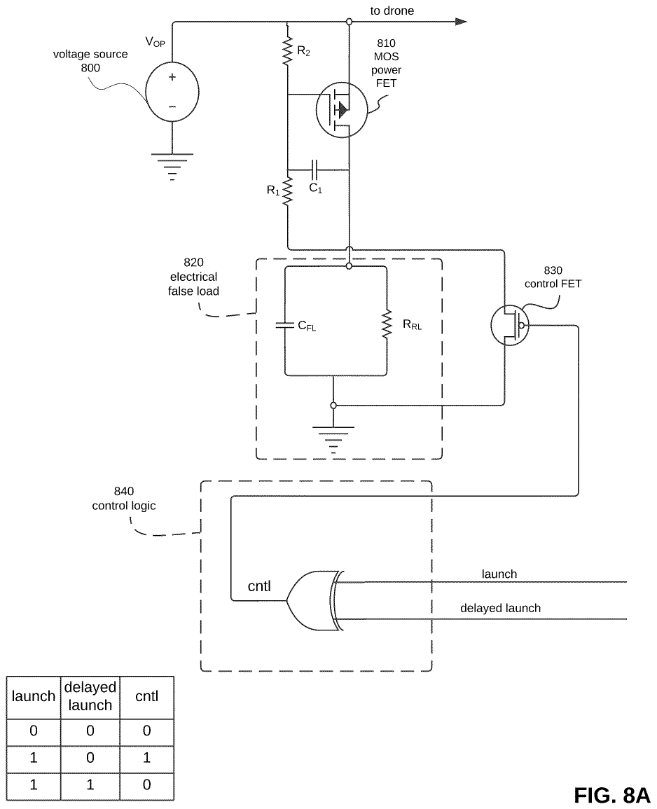

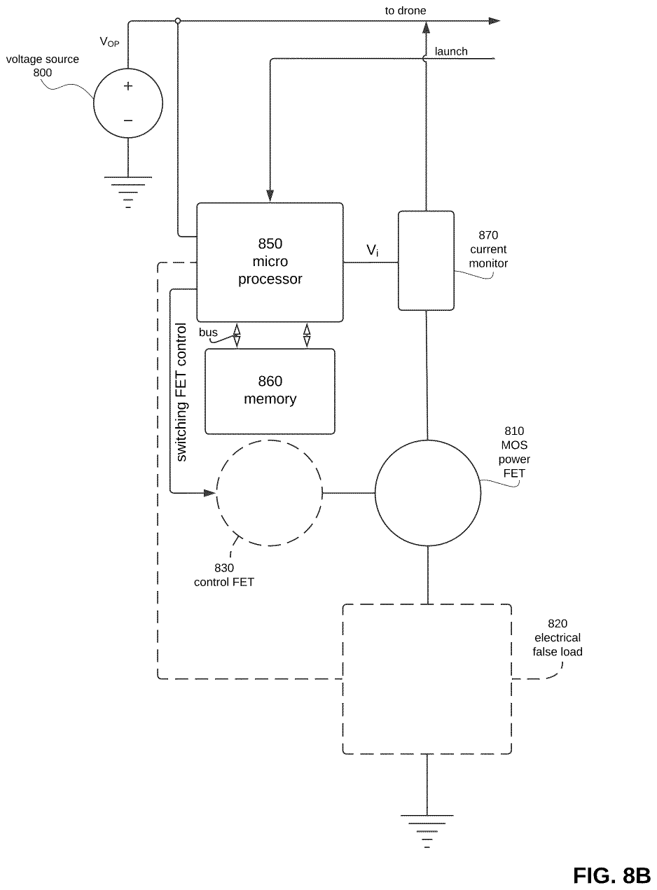

FIG. 8A illustrates an exemplary analog circuit that can be used to implement a delayed launch signal as disclosed by the example embodiments. As shown, voltage source 800 representing generator 100 produces a voltage at operating level V_{OP}. Control logic 840 is used to receive launch and delayed launch signals and based on the logic illustrated in the logic table, produce a control signal to control Field Effect Transistor (FET) 830. Control FET 830 controls a metal oxide semiconductor (MOS) power FET to connect electrical false load 820 to voltage source 800 (generator 100), though other connection techniques and substances could be employed. In an embodiment, the launch signal is generated (e.g. launch=1) and the cntl signal becomes equal to 1 causing control FET 830 to turn on and present a false power load to voltage source 800 via MOS power FET 810. Once the delayed launch signal goes high (delayed launch=1) the cntrl signal goes low (cntl=0) and the false load turns off via control FET 830. As one of skill in the art would understand, the condition of the launch signal being equal to zero and delayed launch signal being equal to 1 does not occur because the launch signal is necessary to generate the delayed launch signal. Other logic designs can be utilized.

FIG. 8B illustrates a representative digital embodiment in which a microprocessor 850 works with an external memory 860 having code stored controls the system 10 to implement the process described in connection with FIG. 5. In addition to controlling the use of electrical false load 820, the microprocessor 850 can be used in conjunction with current monitor 870 to determine the response of generator 100 to the load applied via electrical false load 820.

In an embodiment, the digital system illustrated in FIG. 8B can be used to characterize the response of generator 100 to a load by varying electrical false load 820 in a controlled manner and recording the voltage and current output of the generator over time. By varying false load 820 both in terms of the load and timing of the load, and through repeated measurements the response of the generator can be determined.

In an embodiment, the current utilized by the load (e.g. drone) is also characterized and the demand characteristics of the load determined. This information can be used in conjunction with the characterization of the generator to develop a specific signal that can be applied to control FET 830 to cause MOS power FET 810 to apply electrical false load 820 in a manner that minimizes the launch delay while providing adequate time for generator 100 to spin up.

In addition to false electrical loads, false mechanical loads can be presented in which drone 100 attempts to launch, but is mechanically held in place until the delayed launch signal is received. In this embodiment, the drone motors spin up and cause mechanical work to be performed but without having an actual launch. As such voltage dips and irregularities in the operation of the rotor motors do not impact flight since the drone has not been launched.

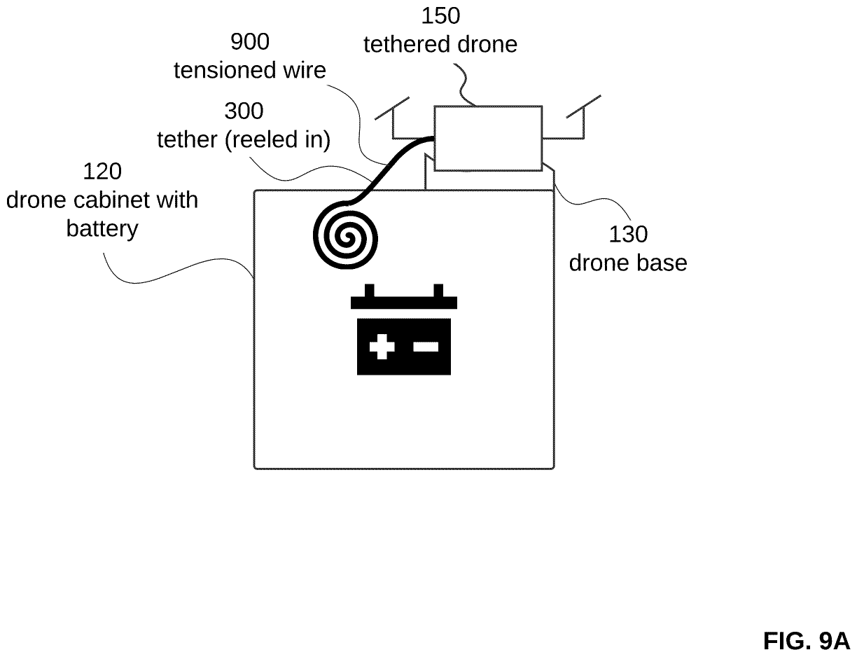

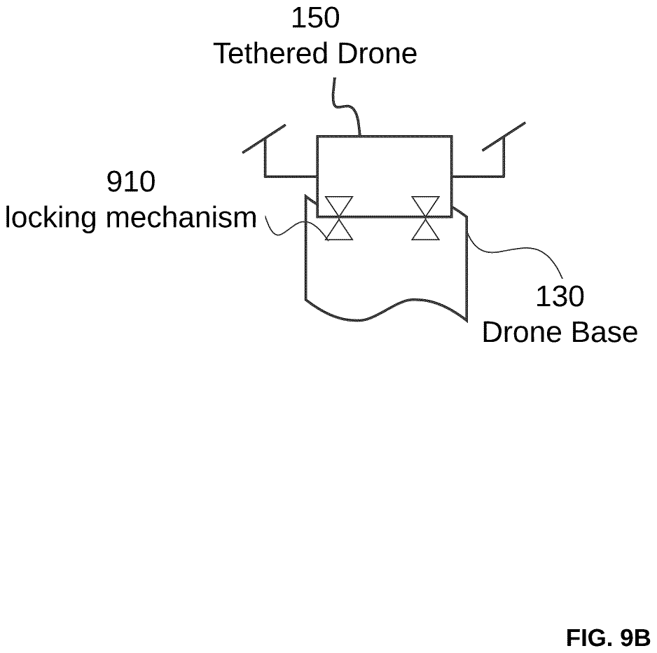

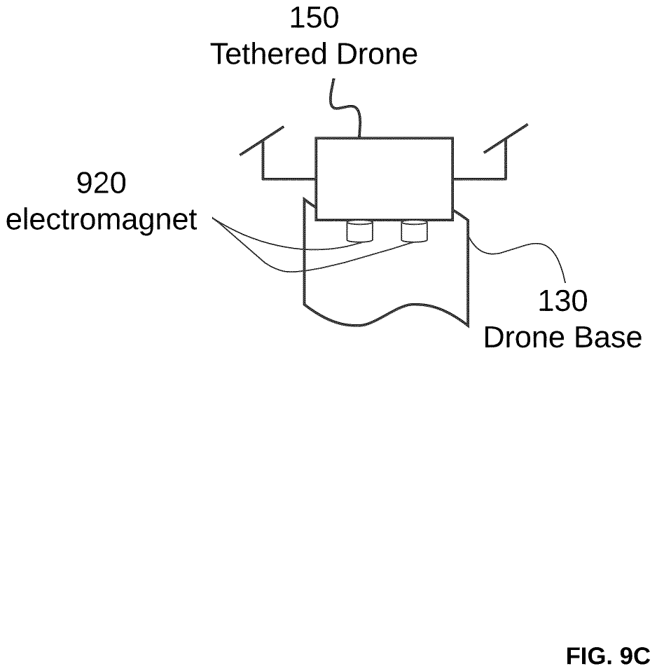

FIGS. 9A, 9B and 9C illustrate mechanical systems for constraining the drone. FIG. 9A shows use of the tether to restrain the drone in a tether reeled in position through use of a tensioned wire 900 contained within lighted tether 140. FIG. 9B shows use of a locking mechanism 910 which in an embodiment is an electromechanically activated lock that can be engaged upon receipt of the launch signal and released upon receipt of the delayed launch signal. FIG. 9C illustrates use of one or more electromagnets 920 to restrain tethered drone 150. Electromagnet 920 can be activated upon receipt of the launch signal and deactivated upon receipt of the delayed launch signal.

In one example embodiment, a method for managing power delivery from a generator to a load includes: receiving a launch signal indicating a request for power delivery, wherein the launch signal requests launch of the load; presenting, in response to the received launch signal, an artificial load to the generator that causes the generator to increase electrical power output, wherein the artificial load reflects the load; generating, in response to the received launch signal, a delayed launch signal upon expiration of a predetermined time; disconnecting, in response to the delayed launch signal, the artificial load presented to the generator; and connecting, in response to the delayed launch signal, an actual load corresponding to the load to the generator.

In another example, the load is a drone.

In another example, the drone is attached to a base by a tether, and wherein the tether supplies the electrical power output of the generated to the drone.

In another example, the tethered drone is mechanically secured to a drone base.

In another example, the mechanically secured includes at least one of: a tensioned tether wire, one or more electromagnets, or a locking mechanism.

In another example, the method of power delivery further include initiating a timer for the predetermined period of time in response to the received launch signal.

In another example embodiment, a system for power deliver is disclosed. The system includes a generator coupled to a launch base supporting a load; wherein the launch base includes a processor configured to: detect a launch signal indicating a request for power delivery, wherein the launch signal requests launch of the load; communicate, in response to the received launch signal, an artificial load to the generator that causes the generator to increase electrical power output, wherein the artificial load reflects the load; generate, in response to the received launch signal, a delayed launch signal upon expiration of a predetermined time; disconnect, in response to the delayed launch signal, the artificial load presented to the generator; and connect, in response to the delayed launch signal, an actual load corresponding to the load to the generator.

In another example, the load is a drone.

In another example, the drone is attached to a base by a tether, and wherein the tether supplies the electrical power output of the generated to the drone.

In another example, the tethered drone is mechanically secured to a drone base.

In another example, mechanically secured encompasses at least one of: a tensioned tether wire, one or more electromagnets, or a locking mechanism.

In another example, the processor is further configured to initiate a timer for the predetermined period of time in response to the received launch signal.

In another example embodiment, a method for managing power delivery to a drone is disclosed. The method includes detecting a launch signal indicating a request for power delivery, wherein the launch signal requests launch of the drone; securing, in response to the received launch signal, the drone to a launch base; presenting, in response to the received launch signal, an artificial load to the generator that causes the generator to increase electrical power output, wherein the artificial load reflects the drone; generating, in response to the received launch signal, a delayed launch signal upon expiration of a predetermined time; disconnecting, in response to the delayed launch signal, the artificial load presented to the generator and the drone from the launch base; and connecting, in response to the delayed launch signal, an actual load corresponding to the load to the generator.

In another example, the drone is a tethered drone.

In another example, the tethered drone is attached to the launch base, and wherein the tether supplies the electrical power output of the generated to the drone.

In another example, the tether provides a tether force to secure the tethered drone relative to the launch base.

In another example, securing the drone includes engaging one or more electromagnets mounted in the launch base.

In another example, securing the drone includes engaging a locking mechanism mounted in the launch base.

In another example, the method further includes initiating a timer for the predetermined period of time in response to the received launch signal.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method for managing power delivery from a generator to a load, comprising:
receiving a launch signal indicating a request for power delivery, wherein the launch signal requests launch of the load;
presenting, in response to the received launch signal, an artificial load to the generator that causes the generator to increase electrical power output, wherein the artificial load reflects the load;
generating, in response to the received launch signal, a delayed launch signal upon expiration of a predetermined time;
disconnecting, in response to the delayed launch signal, the artificial load presented to the generator; and
connecting, in response to the delayed launch signal, an actual load to the generator corresponding to the load.

2. The method of claim 1, wherein the load is a drone.

3. The method of claim 2, wherein the drone is attached to a base by a tether, and wherein the tether supplies the electrical power output of the generator to the drone.

4. The method of claim 3, wherein the drone is mechanically secured to a drone base.

5. The method of claim 4, wherein the drone is mechanically secured by at least one of: a tensioned tether wire, one or more electromagnets, or a locking mechanism.

6. The method of claim 1 further including:
initiating a timer for the predetermined time in response to the received launch signal.

7. A system for power deliver, the system comprising:
a generator coupled to a launch base supporting a load;
wherein the launch base includes a processor configured to:
detect a launch signal indicating a request for power delivery, wherein the launch signal requests launch of the load;
communicate, in response to the received launch signal, an artificial load to the generator that causes the generator to increase electrical power output, wherein the artificial load reflects the load;
generate, in response to the received launch signal, a delayed launch signal upon expiration of a predetermined time;
disconnect, in response to the delayed launch signal, the artificial load presented to the generator; and
connect, in response to the delayed launch signal, an actual load to the generator corresponding to the load.

8. The system of claim 7, wherein the load is a drone.

9. The system of claim 8, wherein the drone is attached to a base by a tether, and wherein the tether supplies the electrical power output of the generator to the drone.

10. The system of claim 9, wherein the drone is mechanically secured to a drone base.

11. The system of claim 10, wherein the drone is mechanically secured by at least one of: a tensioned tether wire, one or more electromagnets, or a locking mechanism.

12. The system of claim 7, wherein the processor is configured to:
initiate a timer for the predetermined time in response to the received launch signal.

13. A method for managing power delivery to a drone, the method comprising:
detecting a launch signal indicating a request for power delivery, wherein the launch signal requests launch of the drone;
securing, in response to the received launch signal, the drone to a launch base;
presenting, in response to the received launch signal, an artificial load to a generator that causes the generator to increase electrical power output, wherein the artificial load reflects the drone;
generating, in response to the received launch signal, a delayed launch signal upon expiration of a predetermined time;
disconnecting, in response to the delayed launch signal, the artificial load presented to the generator and the drone from the launch base; and
connecting, in response to the delayed launch signal, an actual load to the generator corresponding to the artificial load.

14. The method of claim 13, wherein the drone is a tethered drone.

15. The method of claim 14, wherein the tethered drone is attached to the launch base by a tether, and wherein the tether supplies the electrical power output of the generator to the drone.

16. The method of claim 15, wherein the tether provides a tether force to secure the tethered drone relative to the launch base.

17. The method of claim 13, wherein securing the drone includes engaging one or more electromagnets mounted in the launch base.

18. The method of claim 13, wherein securing the drone includes engaging a locking mechanism mounted in the launch base.

19. The method of claim 13 further comprising:
initiating a timer for the predetermined time in response to the received launch signal.
